(19) United States
(12) Patent Application Publication
(10) Pub. No.: US 2004/0109741 A1
(43) Pub. Date: Jun. 10, 2004

(54) Toggle bolt method and apparatus

(76) Inventor: Joseph Bavaro, Topsfield, MA (US)

Correspondence Address: George E. Kersey, P.O. Box 1073, Framingham, MA, 01701, US

(21) Appl. No.: 10/315,518

(22) Filed: Dec. 10, 2002

(51) Int. Cl. F16B 21/00

(52) U.S. Cl. 411/341

(57) ABSTRACT

Apparatus having a threaded shaft with opposed ends containing a pivotal and spring-loaded arm threaded on the shaft, and a member on one of the ends for drilling into a surface and another member on the other end to permit drilling, wherein the drilling member is an extension of the threaded shaft and the extension is removable from the shaft. In a method of the invention for attaching a fixture to a wall or ceiling the steps include (a) using a toggle bolt to drill into the wall or ceiling; and (b) positioning the toggle bolt within the wall or ceiling until a spring-loaded arm associated with the toggle bolt is able to pivot away from the shaft of the toggle bolt to a position preventing the withdrawal of the toggle bolt after it has been drilled into the wall or ceiling.

### BACKGROUND OF THE INVENTION

This invention relates to the adaptation of standard toggle bolts to facilitate the installation of devices that are intended for toggle retention.

The standard toggle bolt is formed by a threaded shaft upon which are threaded pivoted arms that are spring-loaded and collapsible against the shaft but are extendable away from the shaft after the bolt has been inserted through an aperture in, for example, a wall so that upon insertion of the toggle bolt through the aperture, the arms are folded against the shaft until the bolt clears the aperture so that the arms can expand and prevent the withdrawal of the bolt through the aperture.

Thus, when a fixture is to be installed against a wall or ceiling using a toggle bolt, the installer typically inserts the toggle bolt into the wall by drilling a hole of suitable size in the wall, and then inserting the toggle bolt, followed by using the inserted toggle bolt to install the fixture. If an attempt is made to install the fixture and the toggle bolt simultaneously, it is necessary to have help in order to line up the fixture and then secure it using the toggle bolt. As a result, this usually requires several steps.

Accordingly, it is an object of the invention to facilitate the installation of fixtures and the like using toggle bolts. A related object is to reduce the number of steps required in the installation procedure.

Another object of the invention is to expedite toggle bolt installations and reduce the amount of time needed to perform such installations.

A related object is to increase accuracy in the installation of fixtures on walls and ceilings.

### SUMMARY OF THE INVENTION

In accomplishing the foregoing and related objects, the invention provides a threaded shaft having opposed ends and a pivotal and spring-loaded arm threaded on the shaft, with one end of the shaft adapted for drilling into a surface, and the other end adapted to permit drilling.

In accordance with one aspect of the invention, the drilling is accomplished by an extension of the threaded shaft. The extension can be removed from the shaft, for example, by threading.

In accordance with another aspect of the invention the drilling is permitted by structure that is engageable by apparatus for drilling, which can include an adjustable chuck for gripping the shaft. The shaft can include a plurality of spring-loaded arms, which can be oppositely positioned, and drilling can be by an integral portion at the end of the shaft.

In accordance with a method of the invention for attaching a fixture to a wall or ceiling, the steps can include (a) using a toggle bolt to drill into the wall or ceiling; and (b) positioning the toggle bolt within the wall or ceiling until a spring-loaded arm associated with the toggle is able to pivot away from the shaft to a position preventing the withdrawal of the toggle after it has been drilled into the wall or ceiling.

In accordance with one aspect of the method, the toggle bolt has a shaft, on which is positioned an instrumentality for drilling, for example, by threading the instrumentality on the shaft or by integrating the instrumentality into the shaft.

In accordance with another aspect of the invention, the shaft has an end opposite the drilling end for engagement by drilling apparatus.

Where the toggle bolt is adhered to a fixture, drilling takes place by the combination of the toggle bolt and the fixture.

In a method of the invention, for providing a drillable toggle bolt, the steps include (a) forming a toggle bolt, and (b) fixing to the toggle bolt an instrumentality for the drilling of the same into a wall or ceiling. The toggle bolt can be of tool steel in order to adapt it for drilling into hard surfaces.

### DESCRIPTION OF THE DRAWINGS

Other aspects of the invention become apparent after considering several illustrative embodiments taken in conjunction with the drawings, in which:

FIG. 1 is a diagram of a toggle bolt of the invention upon which is threaded a drill tip end.

FIG. 2 is a diagram of an alternative toggle bolt of the invention with a bolt head opposite an integrated drill tip end.

FIG. 3 is a diagram illustrating the result of drilling into a wall or ceiling with a toggle bolt of the invention..

FIG. 4 is a cross-sectional view of the treadable drill tip end for the toggle bolt of FIG. 1.

FIG. 5A is a perspective view of the collar of FIGS. 1-3; and

FIG. 5B is a top view of the collar of FIG. 5A.

### DETAILED DESCRIPTION

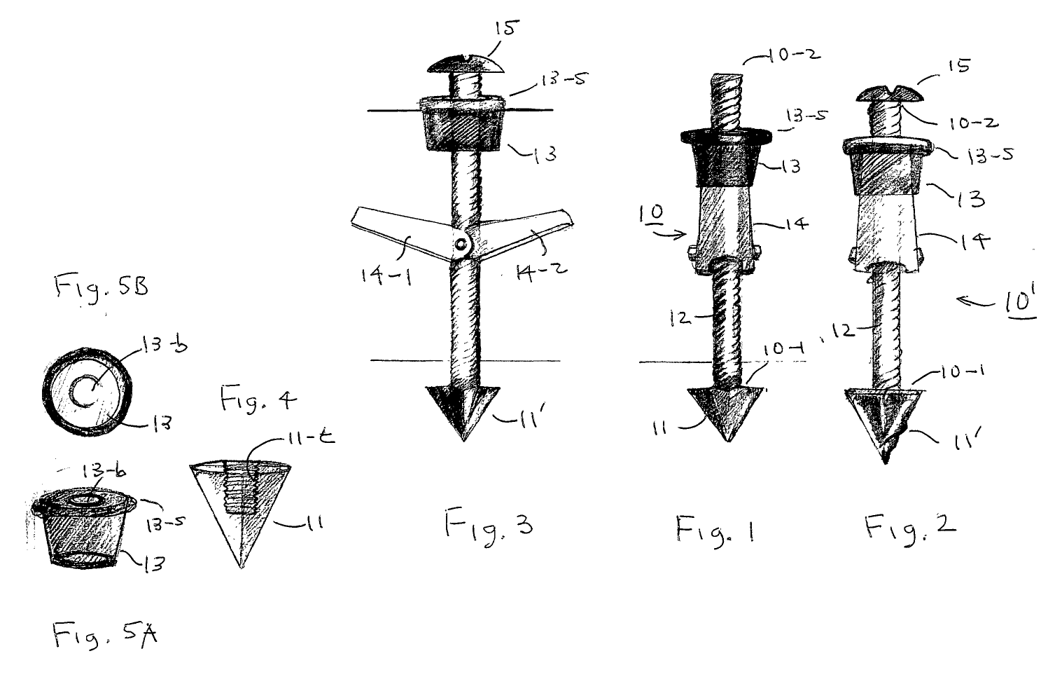

With reference to FIG. 1, a toggle bolt 10 of the invention has a drill tip 11 threaded on one end 10-1 of the bolt shaft 12, and a slip bushing or collar 13 pressed over the closed toggle 14, which has spring-loaded arms 14-1 and 14-2 pressed against the shaft 12. The bushing 13 can have inside treads (not shown) to grab the depressed toggle 14. The opposite end 10-2 of the bolt shaft 12 can be adapted in a variety of ways to allow the bolt 10 to driven through a wall of other structure.

When the bolt 10 is drilled sufficiently through a wall or other surface, as indicated in FIG. 3, the bushing 13 is released and the arms 14-1 and 14-2 can open. The bushing 13 also acts as a sleeve 13-s against a hole drilled in the wall or other surface.

In the embodiment of FIG. 2, the toggle bolt 10′ is fitted with an integrated drill tip 11′ at the end 10-1, and the opposite end 10-2 has slotted bolt head 15. In the embodiment of FIG. 1 a standard toggle, is retrofitted by the drill tip 11 and a bushing 13. Where excessive stress may be encountered, a toggle can be made from standard cold rolled steel.

FIG. 4 is a cross-sectional view of the treadable drill tip end 11 for the toggle bolt of FIG. 1, showing internal threads 10-t that allows the end 11 to be threaded on the shaft end 10-1.

FIG. 5A is a perspective view of the slip bushing or collar 13 of FIGS. 1-3. The collar has a retention sleeve 13-s that exceeds the diameter of the hole formed by the tip 11 or 11′, so that the slleve is retained against the wall or surface into which the bolt 10 is driven, allowing the arms 14-1 and 14-2 to be released after the bolt is pushed or drilled further. The bore 13-b can be smooth or threaded.

FIG. 5B is a top view of the collar 13 of FIG. 5A.

Since the head of many toggle bolts is too large to fit into a standard screw tip-holder, another embodiment is an attachment for any prior art tip-holder (not shown). This is designed to stabilize the drill tip, and allow the drill to deliver enough torque to accomplish installation.

The toggle bolt head can fit into a diameter wide enough to facilitate using a tip with different bolt size heads.

Concrete block and concrete ceilings that have hollow pockets require the toggle bolt to be made out of tool steel, so that no additional tooling would be required.

When installing a fixture of any length and size in a hollow wall or ceiling, the installer requires help to line up and secure the fixture. This usually requires several steps. First, drilling the surface of the item being installed; second, drilling the surface of the material into which installation is made; third, lining up the item being installed, and fourth, insuring the fastener is fully opened and has properly secured the item. The toggle apparatus of the invention can take up more internal surface area and thus create greater strength and holding power.

It will be understood that the foregoing detailed description is illustrative only and that modifications and alterations may be made without departing from the spirit and scope of the invention as defined in the appended claims.

What is claimed:

1. Apparatus comprising
a threaded shaft having opposed ends;
a pivotal and spring-loaded arm threaded on said shaft;
means on one of said ends for drilling into a surface; and
means on the other of said ends to permit said drilling.

2. Apparatus as defined in claim 1, wherein the drilling means comprises an extension of said threaded shaft.

3. Apparatus as defined in claim 2, wherein said extension is removable from said shaft.

4. Apparatus as defined in claim 3, wherein said extension is threadable upon said shaft.

5. Apparatus as defined in claim 1, wherein said means to permit said drilling comprises structure that is engageable by apparatus for drilling.

6. Apparatus as defined in claim 5, wherein said apparatus for drilling includes an adjustable chuck and said structure comprises means grippable by said chuck.

7. Apparatus as defined in claim 1, wherein said shaft includes a plurality of spring-loaded arms.

8. Apparatus as defined in claim 7, wherein said spring-loaded arms are oppositely positioned on said shaft.

9. Apparatus as defined in claim 1, wherein said means for drilling is an integral portion at the end of said shaft.

10. The method of attaching a fixture to a wall or ceiling comprising the steps of:
(a) using a toggle bolt to drill into said wall or ceiling; and
(b) positioning said toggle bolt within said wall or ceiling until a spring-loaded arm associated with said toggle bolt is able to pivot away from the shaft of said toggle bolt to a position preventing the withdrawal of said toggle bolt after it has been drilled into said wall or ceiling.

11. The method of claim 10, wherein said toggle bolt has a shaft, further including the step of positioning means for drilling on said shaft.

12. The method of claim 11, wherein said toggle bolt has a threaded shaft, further including the step of threading the means for drilling on said shaft.

13. The method of claim 10, wherein said toggle bolt has a shaft and means for drilling are integrated into one end of said shaft.

14. The method of claim 13, wherein said shaft has an end opposite said one end, adapted for engagement by drilling apparatus.

15. The method of claim 10, wherein said toggle bolt is adhered to a fixture and said drilling takes place by the combination of said toggle bolt and said fixture.

16. The method of providing a drillable toggle bolt which comprises the steps of:
(a) forming a toggle bolt; and
(b) fixing to said toggle bolt means for the drilling of the same into a wall or ceiling.

17. The method of claim 16, wherein said toggle bolt is of tool steel in order to adapt said bolt for drilling into hard surfaces.

18. The method of claim 16, wherein said means for drilling are threadable on said toggle bolt.

19. The method of claim 16, wherein said means for drilling are permanently attached to said toggle bolt.

20. The method of claim 16, wherein said toggle bolt is adapted for engagement by drilling apparatus.
